(19) United States
(12) Patent Application Publication
(10) Pub. No.: US 2018/0001466 A1
(43) Pub. Date: Jan. 4, 2018

(54) WORKBENCH AND ARTICLES ASSOCIATED THEREWITH

(71) Applicant: KETER PLASTIC LTD., Herzelyia (IL)

(72) Inventor: Yaron BRUNNER, Kibbutz Gvat (IL)

(73) Assignee: KETER PLASTIC LTD., Herzelyia (IL)

(21) Appl. No.: 15/536,443

(22) PCT Filed: Dec. 20, 2015
(86) PCT No.: PCT/IL2015/051231

§ 371 Date: Jun. 15, 2017

Related U.S. Application Data
(60) Provisional application No. 62/093,475, filed on Dec. 18, 2014.

(51) Int. Cl. B25H 1/04; B25H 1/12; A47B 3/12; A47B 13/00; B25H 1/18; B25H 1/16

(52) U.S. Cl. CPC B25H 1/04; B25H 1/18; B25H 1/16; A47B 3/12; A47B 13/003; B25H 1/12

(57) ABSTRACT

Provided is a workbench including a utility member having a top face, a bottom face and side walls and a plurality of support legs. The workbench is manipulable between an operative position in which the support legs are detachably attached at leg mounts configured at the bottom face of the workbench, and a stowed position in which the support legs are detached from the leg mounts and are stowed within leg receptacles. At the stowed position the support legs are fully received within receiving receptacles configured at the utility member and do not project from the utility member.

### TECHNOLOGICAL FIELD

The present disclosure is directed to a DIY work bench and more particularly it is concerned with a knockdown type DIY workbench deployable between an operative position and a stowed position. In addition the present disclosure is directed to various accessories associated therewith.

### BACKGROUND ART

References considered to be relevant as background to the presently disclosed subject matter are listed below:
U.S. Pat. No. 6,173,660
US2009272861

Acknowledgement of the above references herein is not to be inferred as meaning that these are in any way relevant to the patentability of the presently disclosed subject matter.

### BACKGROUND

U.S. Pat. No. 6,173,660 discloses a retrofit kit formed by pairs of telescoping legs and a tool anchoring platform for a collapsible leg structure for a metal bench including a T-shaped brace rod having one end of its stem pivotally connected to the underside of the bench and its other end extending between and lockingly engaged with the depending end portion of a pair of the legs. A strut, pivotally connected with the stem of the brace rod, is slidably engaged with a track bracket secured to the undersurface of the bench to limit downward movement of the brace rod with respect to the bench. Links connecting the legs to the strut collapse the legs to a folded position under the bench when the brace rod is manually released from the legs and moved toward the undersurface of the bench.

US2009272861 discloses a saw horse bracket, comprising: a face oriented substantially vertically; a support extending perpendicularly forwardly from the face; the support oriented substantially horizontally, the support having a support aperture; a top extending perpendicularly rearwardly from the face; the top disposed upwardly from the support, the top oriented substantially horizontally; a first side extending forwardly from the face, the first side oriented substantially vertically, the first side having a first side aperture; a second side extending forwardly from the face, the second side oriented substantially vertically, the second side disposed rightwardly of the first side, the second side having a second side aperture; and an overhang extending downwardly from the top, the overhang oriented substantially vertically, the overhang disposed rearwardly from the face, the overhang (60) having an overhang aperture.

### GENERAL DESCRIPTION

According to the present disclosure there is disclosed a workbench comprising a utility member having a top face, a bottom face and side walls and a plurality of support legs, wherein the workbench is manipulable between an operative position in which the support legs are detachably attached at leg mounts configured at the bottom face of the workbench, and a stowed position in which the support legs are detached from the leg mounts and are stowed within leg receptacles.

At the stowed position the support legs are fully received within receiving receptacles configured at the utility member and do not project from the utility member. At the stowed position the overall size of the workbench is that of the utility member itself, with all elements and components thereof being fully received therein, i.e. not projecting from any surface of the utility member.

According to one particular example at the stowed position the support legs are received within a leg receptacle configured at the bottom face of the workbench.

According to one particular example at the stowed position the support legs are received within leg receptacles configured at one or more side walls of the workbench.

Any one or more of the following configurations, designs and embodiments can be associated with the workbench subject of the presently disclosed subject matter, individually or in various combinations thereof:

The support legs are configured at their top end with a mounting arrangement for fast attaching/detaching from the leg mounts;

The support legs can be configured for snap attachment within the leg receptacle, at the stowed position;

The support legs can be configured for sturdy and fast mounting and detaching to/from leg mounts configured at the bottom face of the workbench;

The support legs can be configured for screw-coupling to the leg mounts configured at the bottom face of the workbench;

The support legs can be configured for snap articulation into leg mounts configured at the bottom face of the workbench;

The support legs can be configured with a bayonet type articulation into leg mounts configured at the bottom face of the workbench;

The support legs can be configured at bottom ends thereof with a ground engaging pad;

The ground engaging pad can be configured with anti-slip surfacing;

The ground engaging pad can be configured for tilting about a longitudinal axis of the support leg, to thereby self-adjust to uneven surfaces;

The support legs can be configured for height adjusting, for leveling the utility member;

The workbench can be configured with one or more organizers (e.g. screw organizers) detachably attachable thereto. According to one particular example an organizer is detachably attachable at a bottom face of the utility member;

The organizer can be configured for sealingly attaching thereto the utility member;

The utility member can be configured with receptacles/compartments/trays configured at the top face thereof. Optionally such compartments can be drawer-like receptacles configured at side walls of the utility member;

The utility member can be configured with a carrying handle. According to one particular example the handle is retractable when not in use;

Tool utility member can be configured for detachably attaching thereto utility hooks. Such utility hooks can be used for example for mounting thereon various equipment/gear and for supporting beams which can facilitate for setting up an extended work surface, a scaffold, etc.;

The utility hooks can be configured for supporting rectangular cross-sectioned beams;

The utility member can be configured with modular work utilities, either fixed or replaceable. For example, such work utilities can comprise T-slots, router plates, router fences, measurement indicia, coupling ports, etc.;

At the stowed position the overall thickness of the workbench does not exceed the thickness of the utility member.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1A is a top perspective top view of the work bench subject of the present disclosure, at an operative, erect/assembled position;

FIG. 1B is a perspective bottom view of FIG. 1A;

FIG. 1C is an exploded top perspective top view of FIG. 1A;

FIG. 2A is a bottom perspective view of the workbench, at a carry-along position;

FIG. 2B is a front perspective view of the workbench, at a carry-along position;

FIG. 2C is front perspective view of a modification of the workbench, at a carry-along position;

FIG. 2D is a perspective bottom view of the workbench, at a stowed position;

FIG. 3B is a section taken along line I-I in FIG. 2D;

FIG. 3C is a section taken along line II-II in FIG. 2D;

FIG. 3D is a section taken along line in FIG. 1C, illustrating only the utility member;

FIG. 4A is an enlarged perspective view of the utility member, illustrating a leg mount and bottom end leg arresting members;

FIG. 4B is an enlarged perspective view, at an opposite side of the utility member, illustrating a leg mount and top end leg arresting members;

FIG. 4C is a partial perspective view, sectioned along line IV-IV in FIG. 2D, illustrating a bottom end of a support leg;

FIG. 4D is a partial perspective view, sectioned along line IV-IV in FIG. 2D, illustrating a top end of a support leg;

FIG. 5A is s partial perspective view sectioned through a leg mount;

FIG. 5B is the same as FIG. 5A, with a support leg attached;

FIG. 6A is a perspective view of a support leg;

FIG. 6B is an enlarged view of the portion marked VI in FIG. 6A;

FIG. 6C is a longitudinal section through the bottom leg portion of FIG. 6C;

FIG. 7 is a longitudinal section through the utility member, illustrating a storage space for an organizer;

FIGS. 8A to 8C illustrate consecutive steps of mounting the support legs to the utility member; and

FIGS. 9A to 9N illustrate a variety of accessories configured for use with the workbench subject of the present disclosure.

### DETAILED DESCRIPTION OF EMBODIMENTS

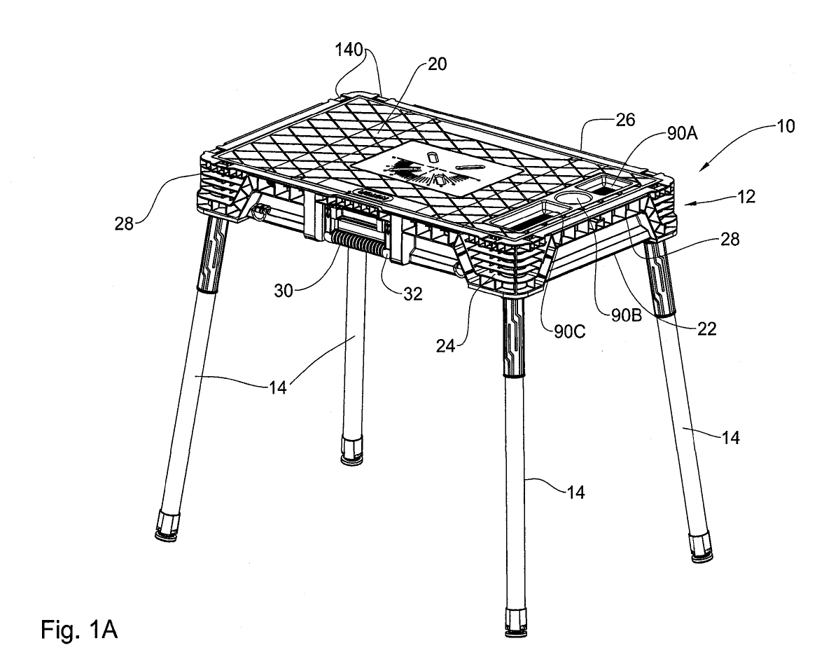

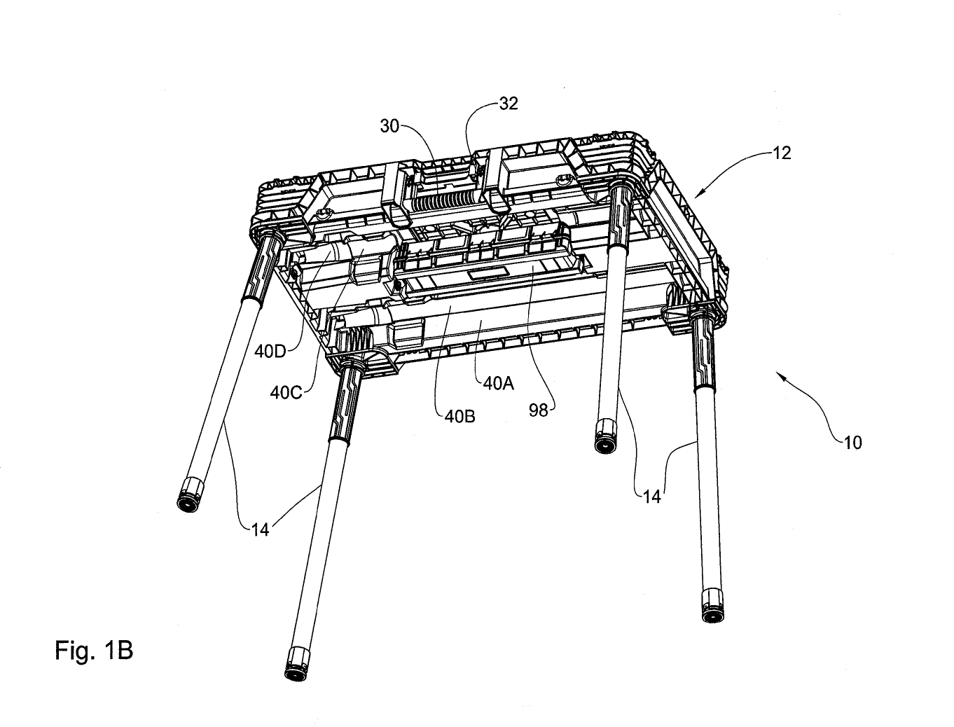

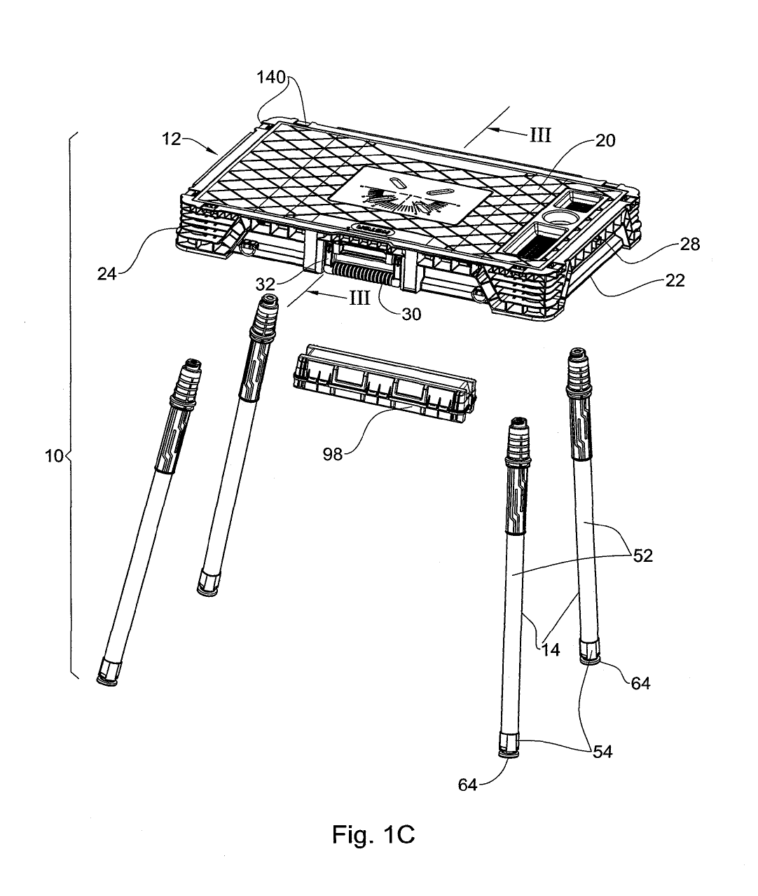

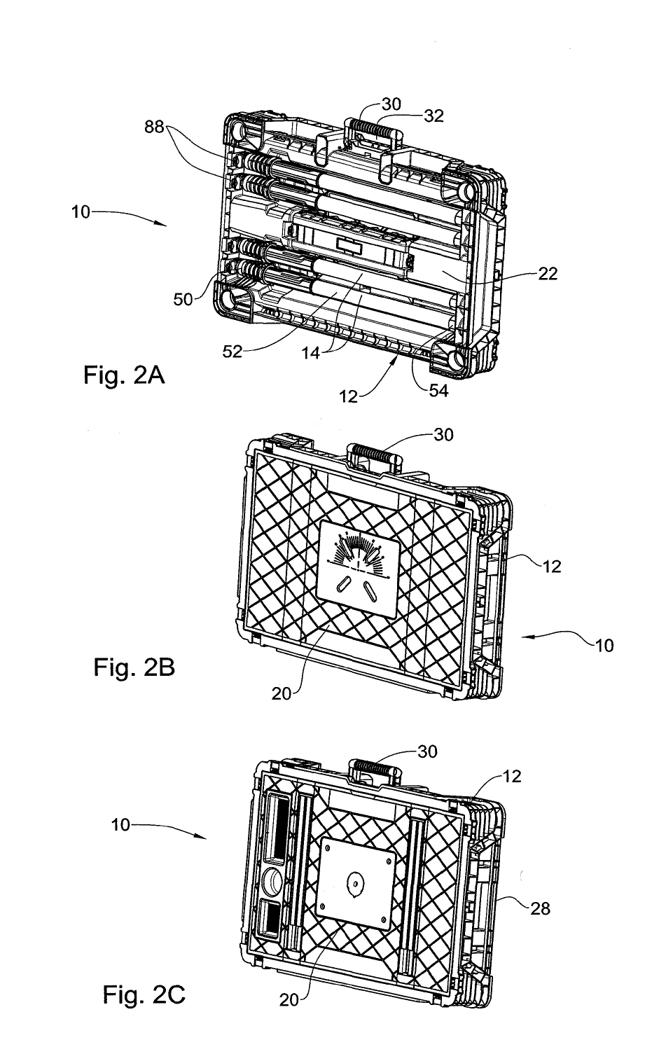

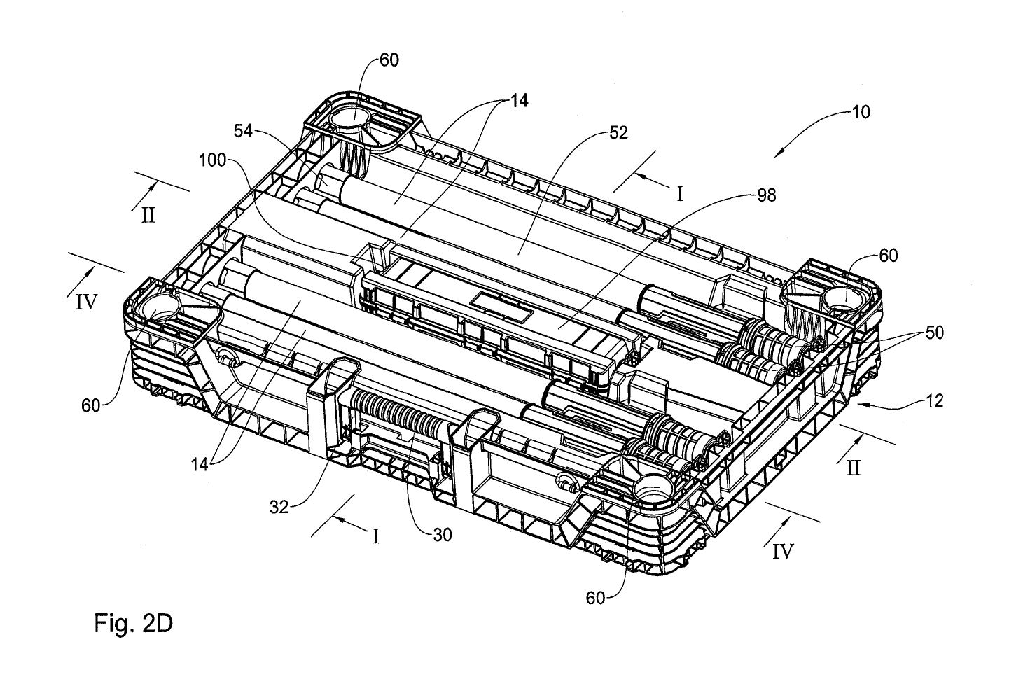

Attention is first directed to FIGS. 1 and 2 of the drawings illustrating a workbench generally designated 10 and comprising a utility member 12 configured with four detachably attachable support legs 14.

The utility member is made of rigid plastic material and has a rectangular shape with a top face 20, a bottom face 22, and four side walls, namely a front wall 24. A back wall 26 and two side walls 28. It is well appreciated that the shape and size of the utility member can be designed differently, however without departing from the principals of the following disclosure. For example the utility member can have a different shape or it can be thicker or larger and comprise more or less support legs, depending on the stability required.

The utility member 12 is configured with a carrying handle 30 characterized in that while not in use in its capacity as a handle, it is disposed into a stow position, so as not to cause an interference, i.e. either drops down into a handle niche 32 or retracts into a handle cavity (not shown).

The workbench 10 is configurable between an operative/utility position (e.g. FIG. 1A), and a stowed position (e.g. FIG. 2A) at which the support legs 14 and any other accessories are fully received within receiving receptacles configured at the utility member 12 and do not project from the utility member. Thus, at the stowed position the overall size of the workbench is that of the utility member itself, with all elements and components thereof being fully received therein, i.e. not projecting from any surface of the utility member.

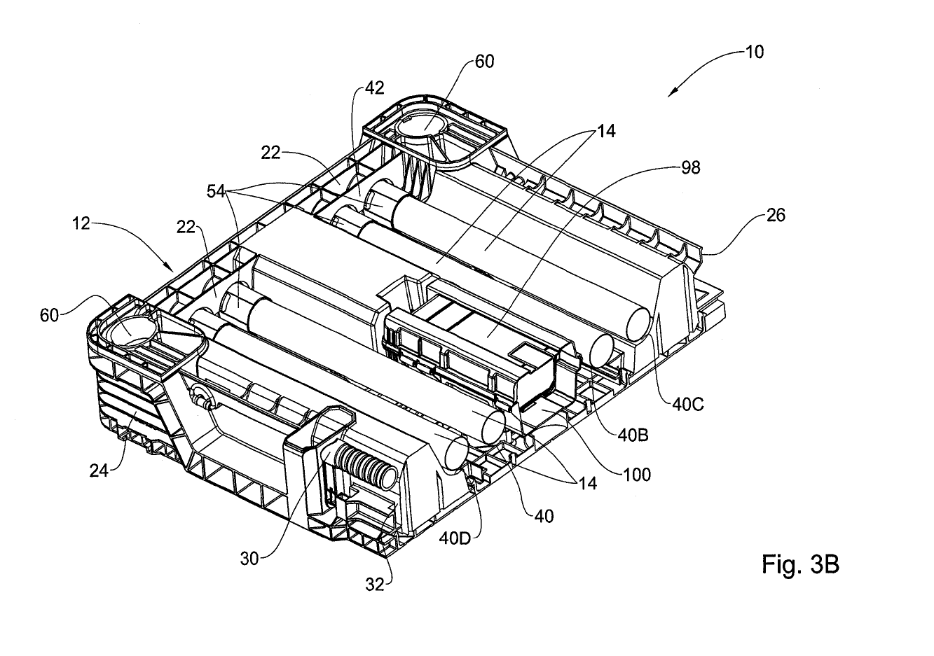

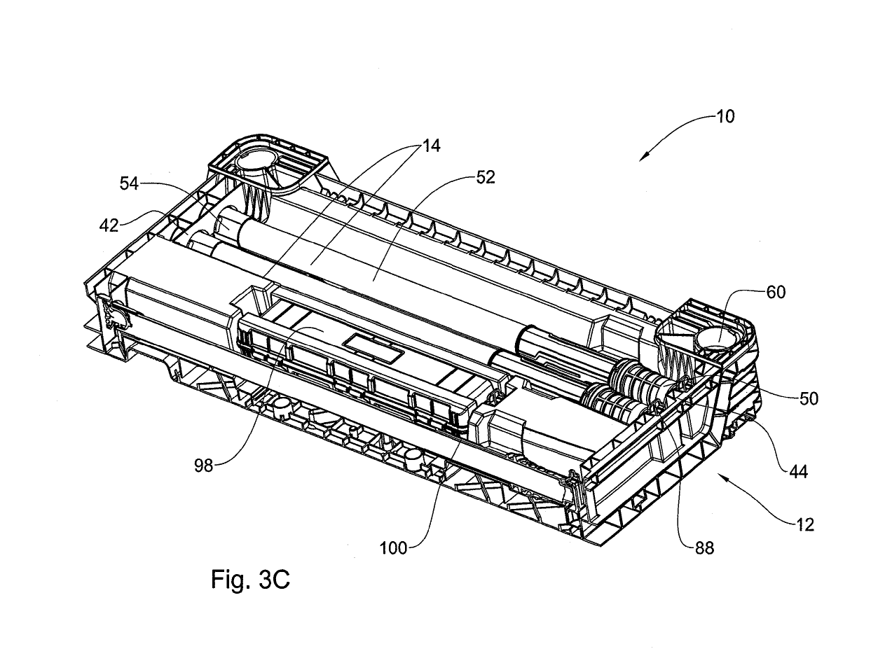

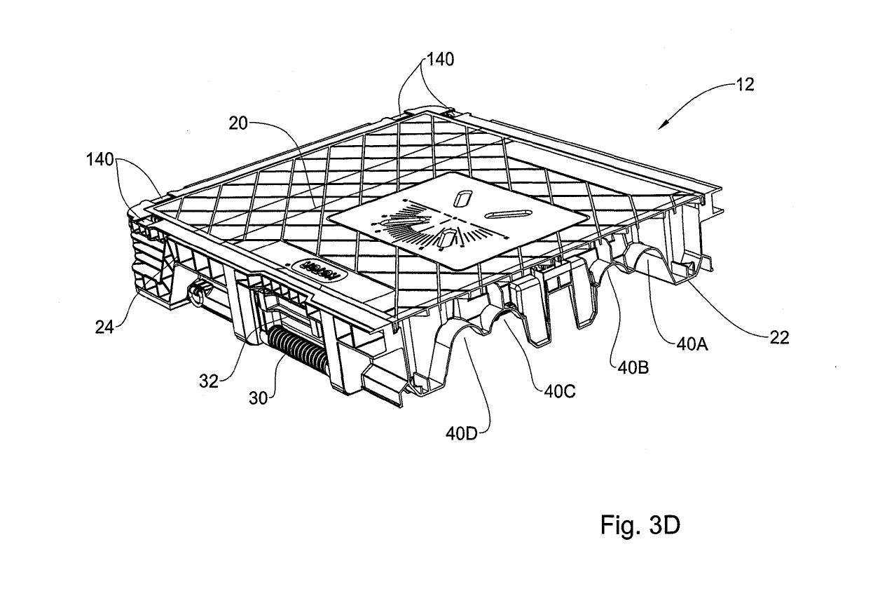

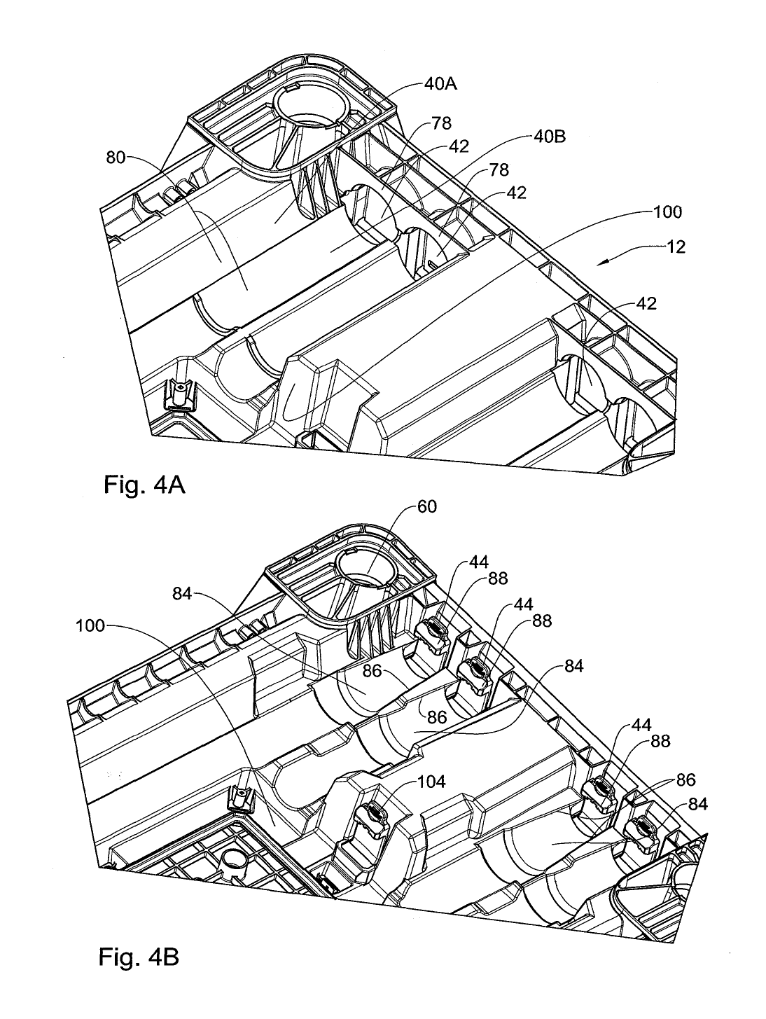

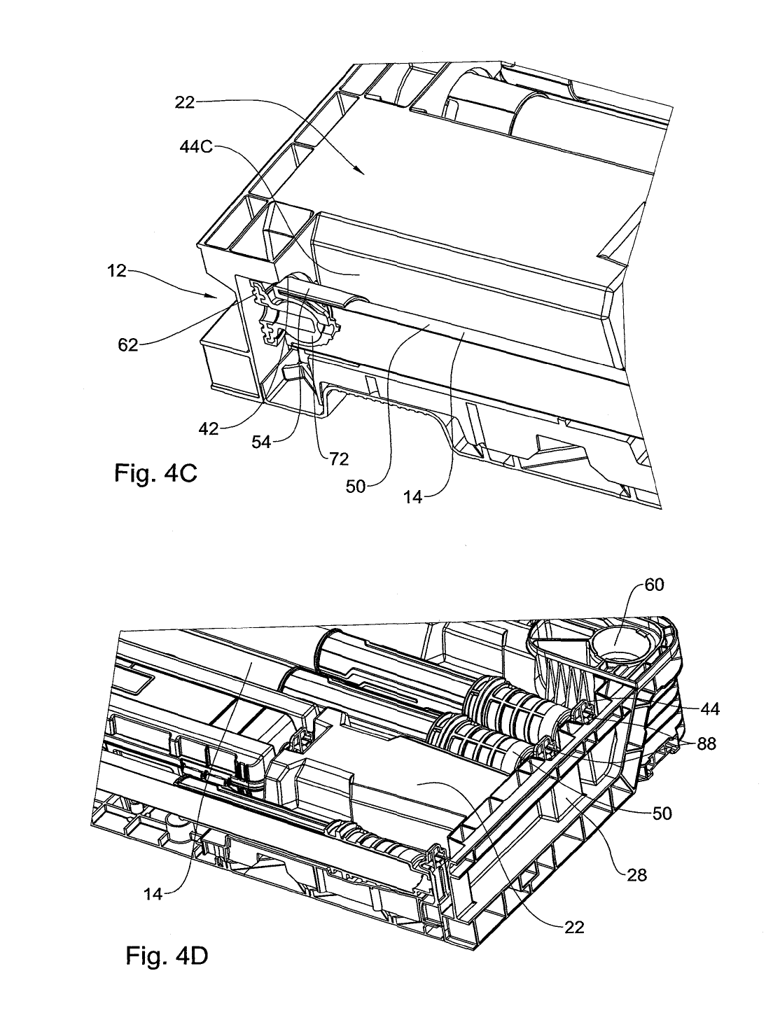

The bottom face 22 of the utility member 12 is configured with four elongate leg receptacles 40C to 40D, configured for receiving and supporting the support legs while not in use (i.e. at the stowed position) in a fashion where the four support legs 14 are firmly secured within the leg receptacles 40A to 40D, yet readily detachable (and readily attachable). It is seen, best in FIG. 3B, that the leg receptacles 40A to 40D have an elongate, trough-like, cross section and are each configured with a bottom end leg arresting member 42 (FIGS. 3B and 4A) and a top end leg arresting member 44 (FIG. 4B), to which reference will be made back? hereinafter. However, as mentioned above and as seen in the drawings (for example, FIGS. 2A, 2D, 3B to 3D), at the stowed position, the support legs 14 do not project in any way from the utility member 12. It is appreciated that the trough-like leg receptacles 40A to 40D increase bent resistance of the utility member 12.

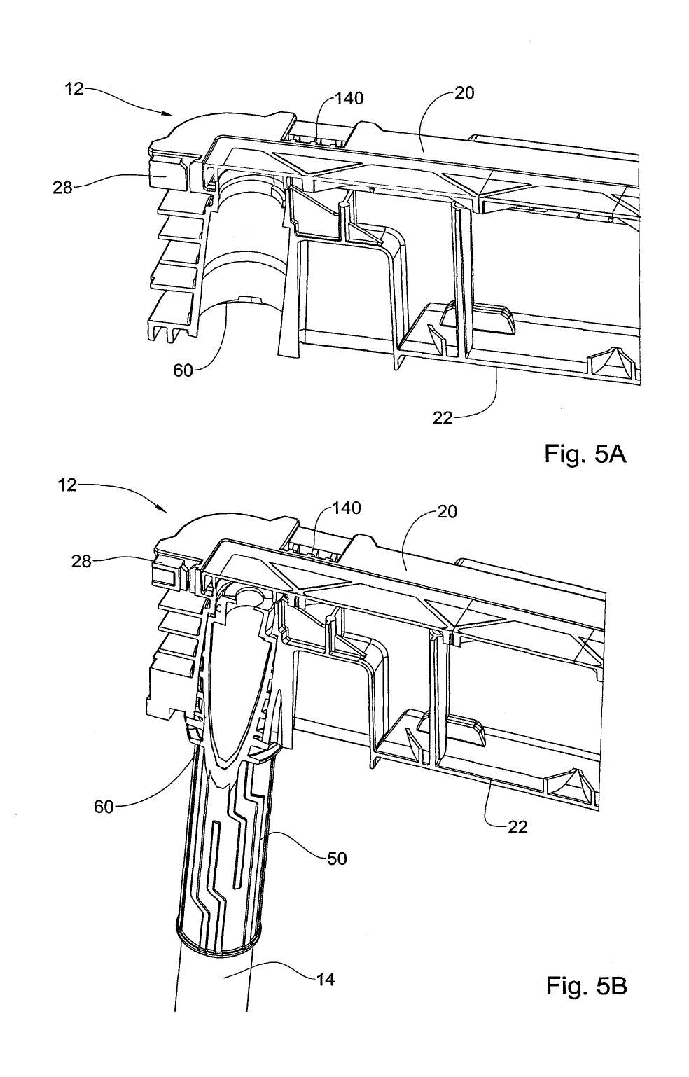

The rigid support legs 14 comprise a top end portion 50 configured with a mounting mechanism as discussed hereinafter, a body portion 52 and a bottom end portion 54. According to a particular example the body portion 52 is made of light weight, yet rigid material such Aluminum, Carbon etc., with plastic end fittings. The mounting mechanism at the top end portion 50 comprises a course thread configured for screw coupling within corresponding leg mounts 60 configured at the bottom face 22 at respective corners thereof (e.g. seen in FIGS. 4A, 5A 5B). The thread can have a square shape or other, and it can be configured with more than one coil. Furthermore, the mounting mechanism can be configured as a bayonet-type mount, as a snap-type mount etc, (not shown).

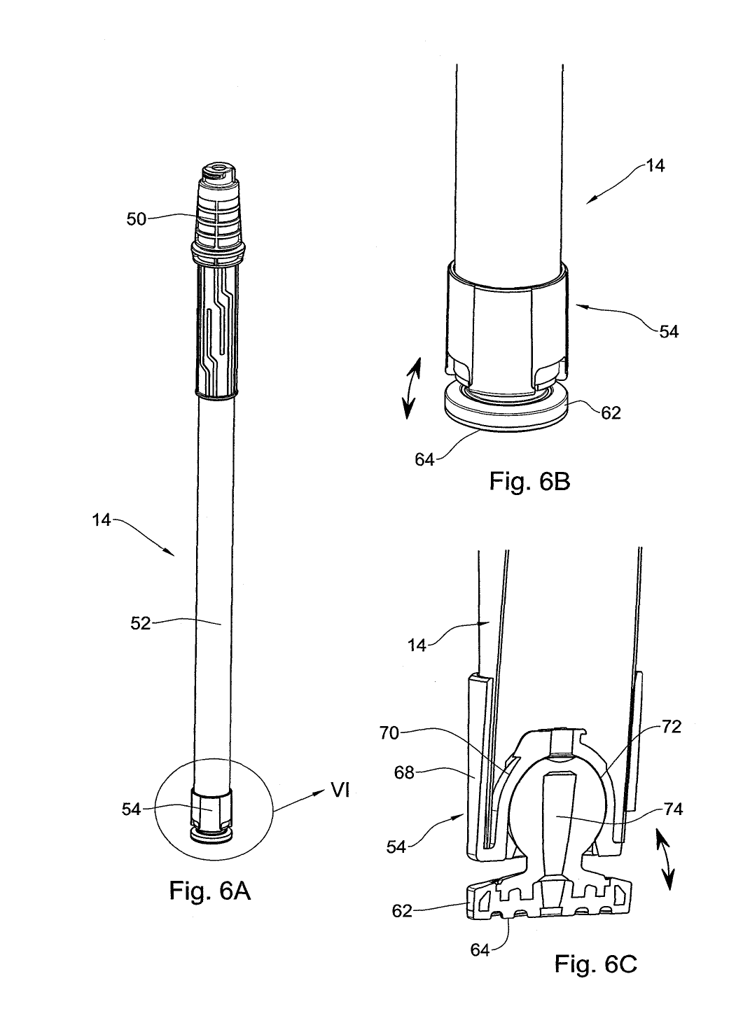

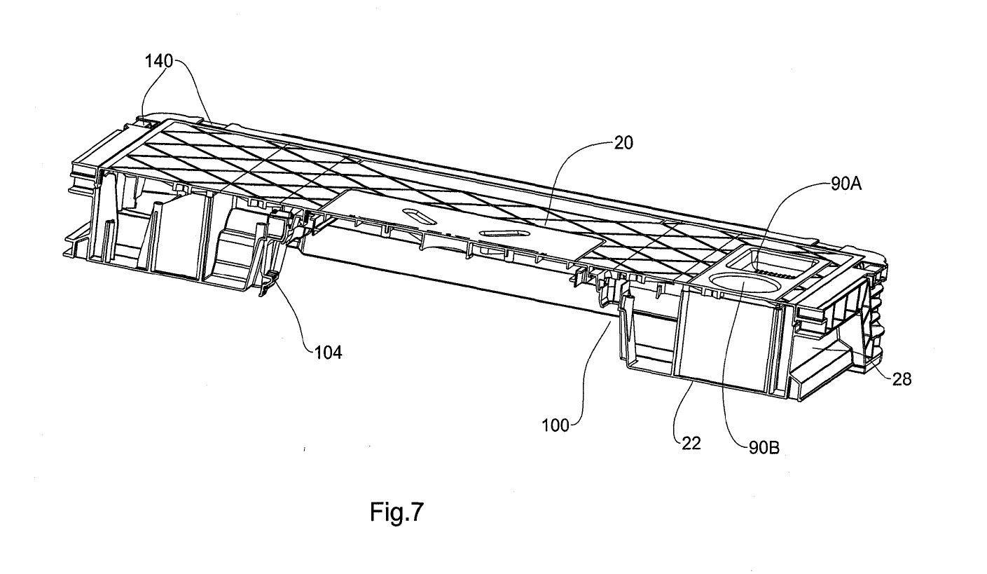

The bottom end portion 54 of the support legs 14 is configured with a self-adjusting surface plate 62, with a bottom face thereof 64 configured with an anti-slip layer. It can be seen in FIG. 6C that the bottom end portion 54 is configured as a ball-type joint comprising a mount member 68 fixedly secured at the bottom end of the body portion 52 and configured with an integral ball socket 70 pivotally accommodating a spheric head 72 configured with a stem 74 extending downwards and carrying the surface plate 62. Thus, spheric head 72 is freely pivotable within the socket 70, facilitating self adjusting of the surface plate 62 over a floor surface. In the particular example the surface plate 62 is pivotable at about 15° (each way) about a longitudinal axis of the support leg 14. According to the particular example, the ball socket 70 and the spherical head 72 (with the associated stem 74 and articulated surface plate 62) are made in a single process.

Reverting now to the leg receptacles 40A to 40D and the top/bottom end leg arresting members 42 and 44 respectively, it is seen that the bottom end leg arresting members 42 (FIGS. 3B and 4A) are configured as a bridge portion 78 over a cradling portion 80 of the leg receptacles 40A to 40D, whereby the bottom end leg arresting member 42 is configured for free inserting thereto the bottom end portion 54 of the support legs. However, the top end leg arresting members 44 (FIG. 4B) are configured as cradling bed portions 84 with tapering side walls 86 for snap arresting with the top end portion 50 of the legs 14, and further there is provided a snap-type lock with a latch 88 for selectively unlocking the snaps so as to release the top end portion 50 of the legs 14 when required.

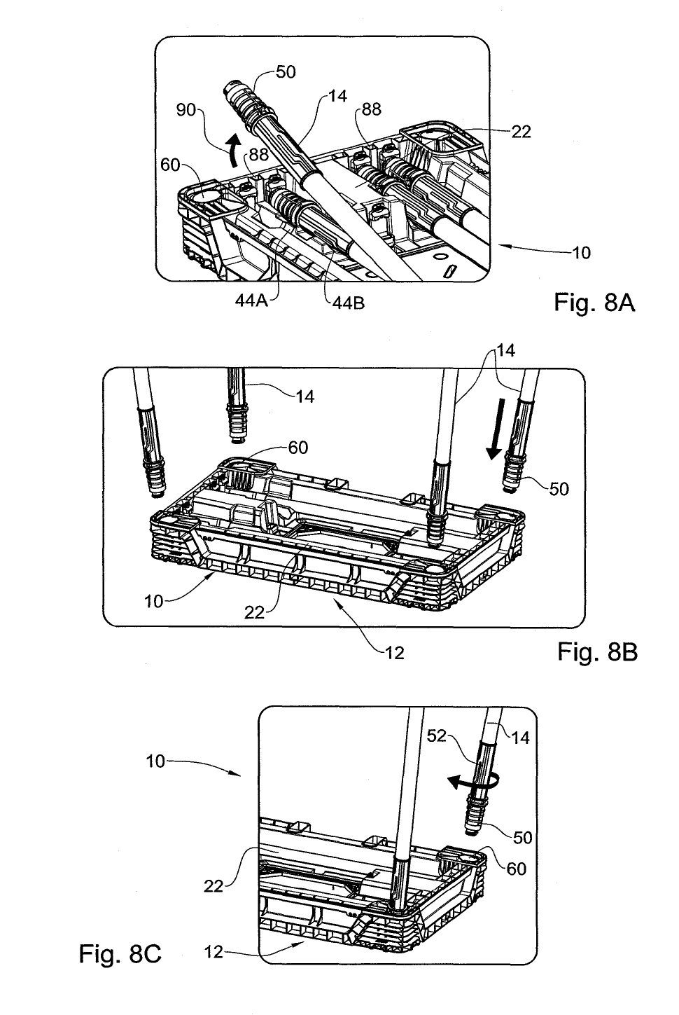

With reference to FIGS. 8A to 8C, deploying the workbench 10 from the stowed position to the operative position, takes place by first removing the support legs 14 from the leg receptacles 40C to 40D (FIG. 8A). Detaching the support legs 14 from the leg receptacles 40A to 40D of the utility member 12 is facilitated by manipulating latches 88 of the top end leg arresting members 44 so as to disconnect from the top end portion 50 whereby the support legs can be removed in direction of arrow 90 and withdrawn from the leg receptacles. Then, the top end portion 50 of support legs 14 are introduced into leg mounts 60 (FIG. 8B) and are finally screw coupled into the leg mounts 60 in a secure fashion, suitable for supporting the workbench 10 and bearing loads and forces applied thereto. Stability of the workbench 10 is achieved, inter alia owing to the inclined axis of leg mounts 60, i.e. such that at the operative position a wide support base is obtained.

Disassembly of the workbench from its operative position into the stowed position takes place in a reverse sequence of operations, i.e. detaching all support legs 14 from the leg mounts 60 of the utility member 12 and storing the support legs at the leg receptacles 40C to 40D.

It is however appreciated that one or both of the top end leg arresting members and the top end leg arresting members can be configured differently, e.g. snap type engaging arms, screw clams, etc.

As can further be seen, for example in FIG. 1A, the top face 20 of the utility member 12 is configured with several compartments/receptacles/trays 90A-90C. These can be useful for accommodating various articles such as screws, nails, drill bits and the like. Optionally, not shown, such compartments can be configured as drawers configured at side walls of the utility member.

As further noted, best in the exploded view of FIG. 1C (though noted also in other Figs. such as 1B, 2D, 3C), the workbench 10 is further configured with a detachably attachable organizer 98 (storage container) for readily and convenient storage of small articles such as screws, nails, drill bits and the like. For that purpose the bottom face 22 of the utility member 12 is configured with a receptacle 100 shaped and sized for accommodating the organizer 98 such that at the attached position the organizer does not project from surfaces of the utility support. The organizer 98 is arrested within the receptacle 100 by a locking latch 104 snapingly securing the organizer within the receptacle 100.

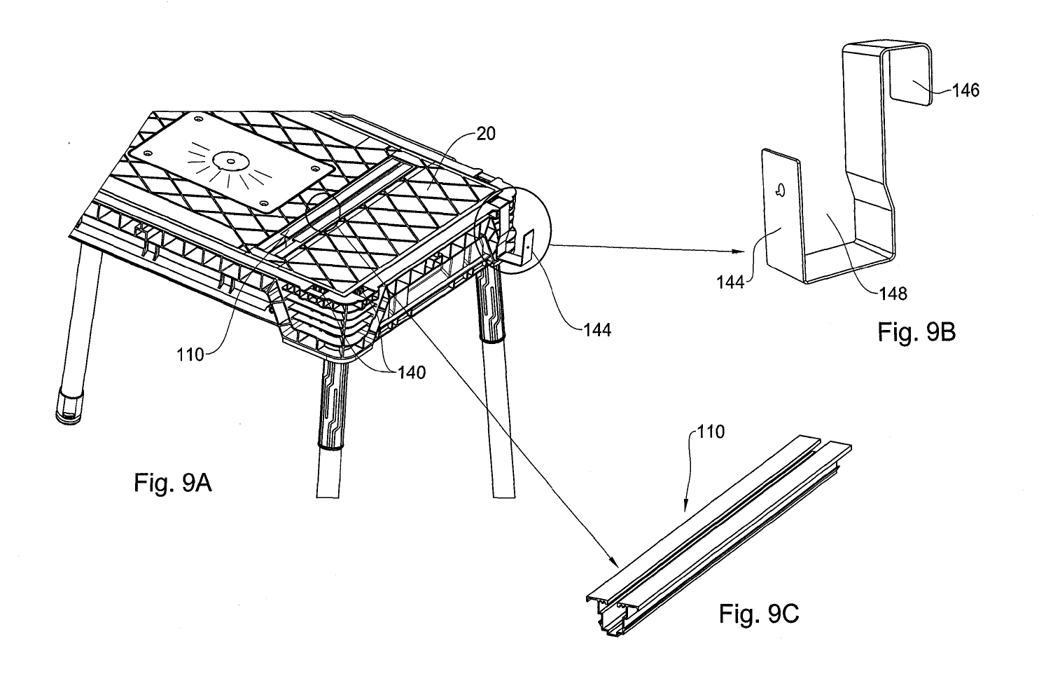

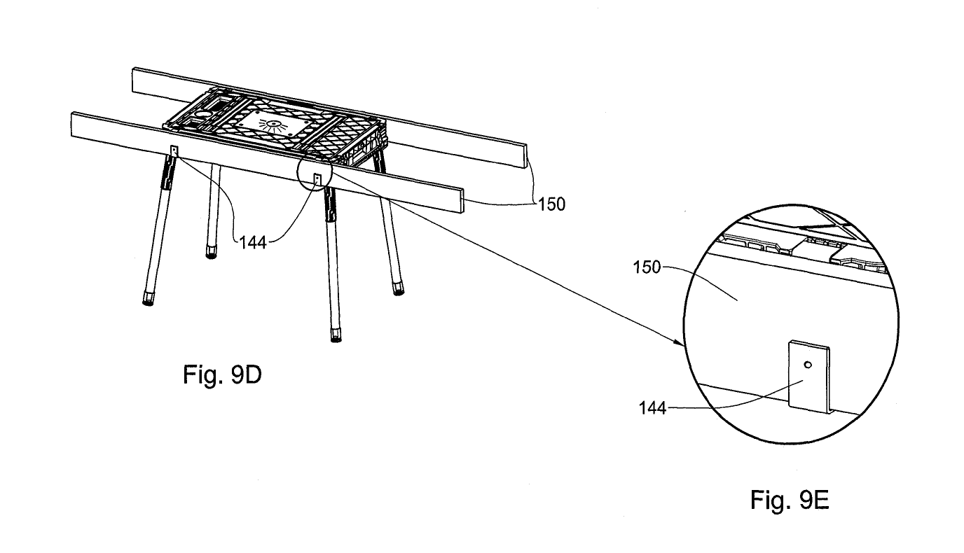

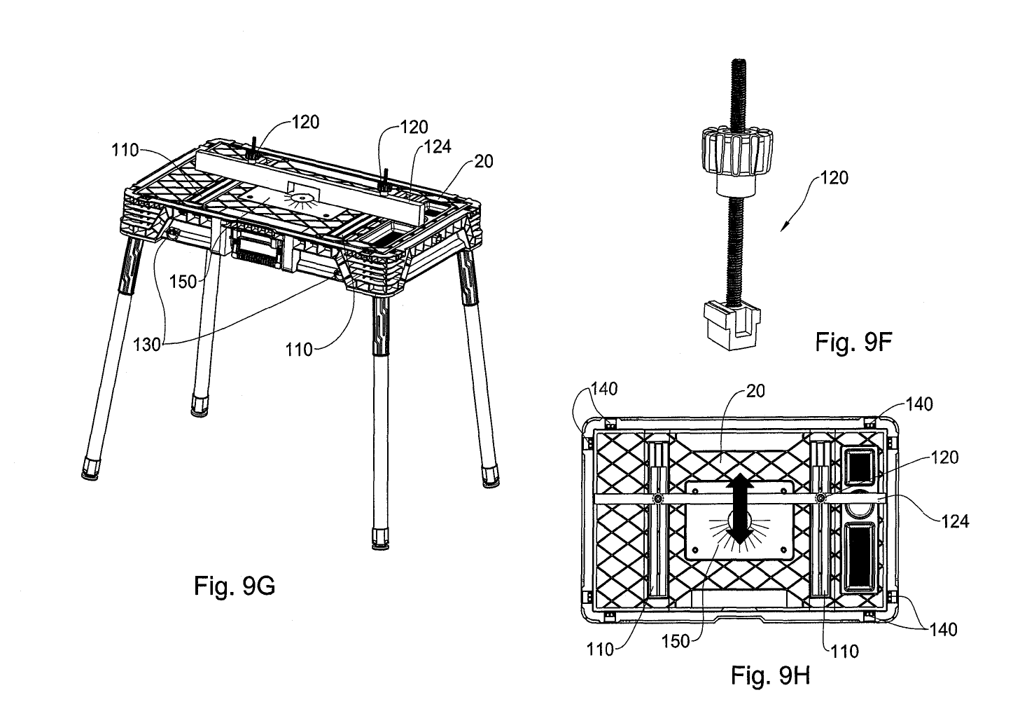

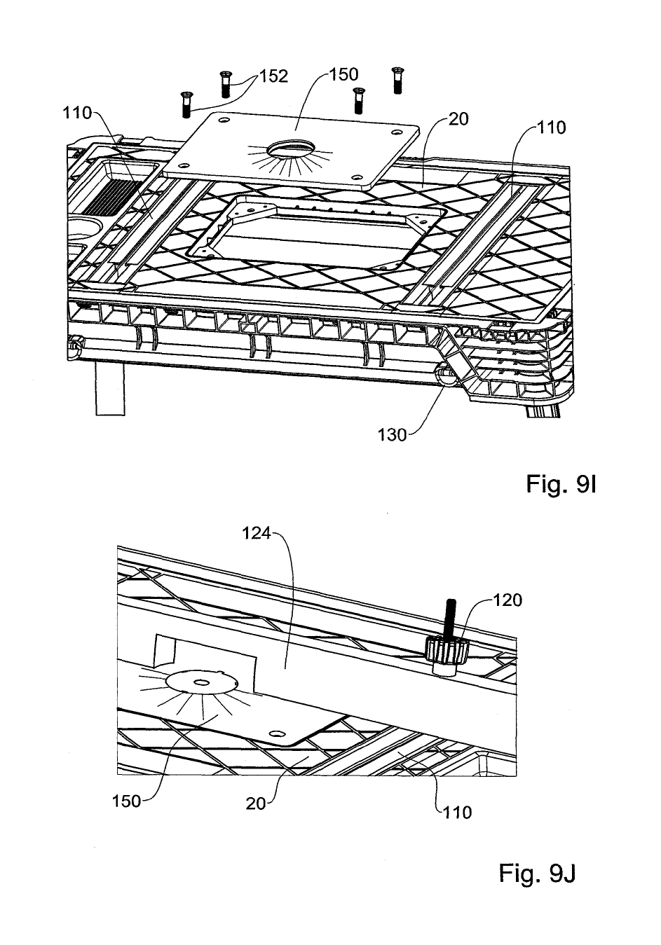

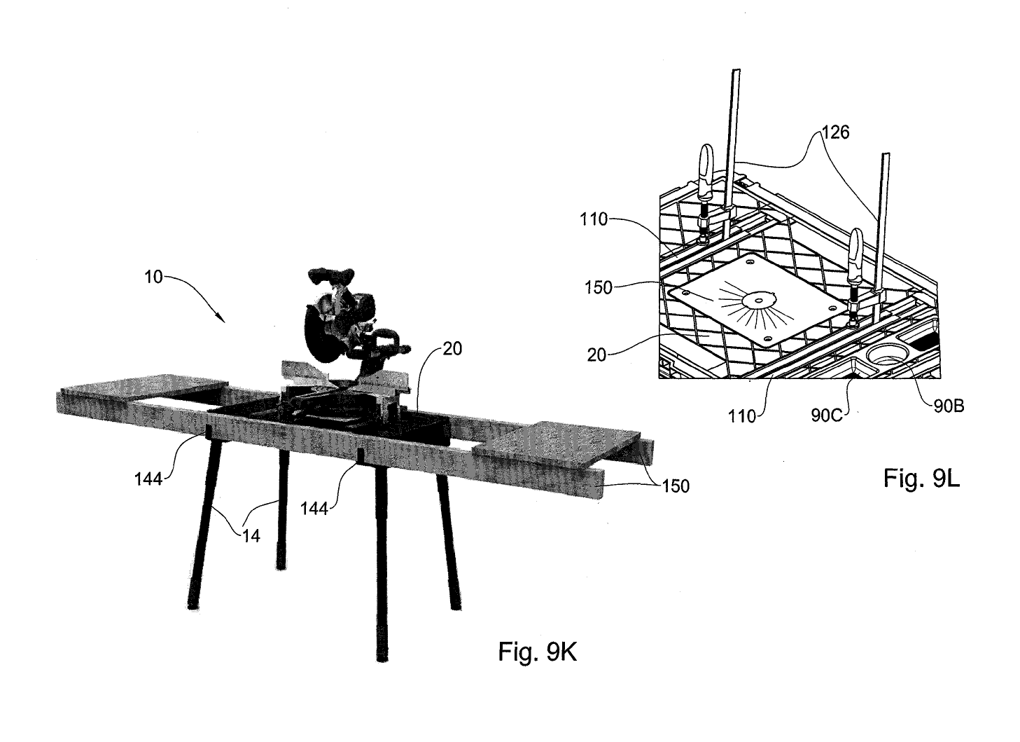

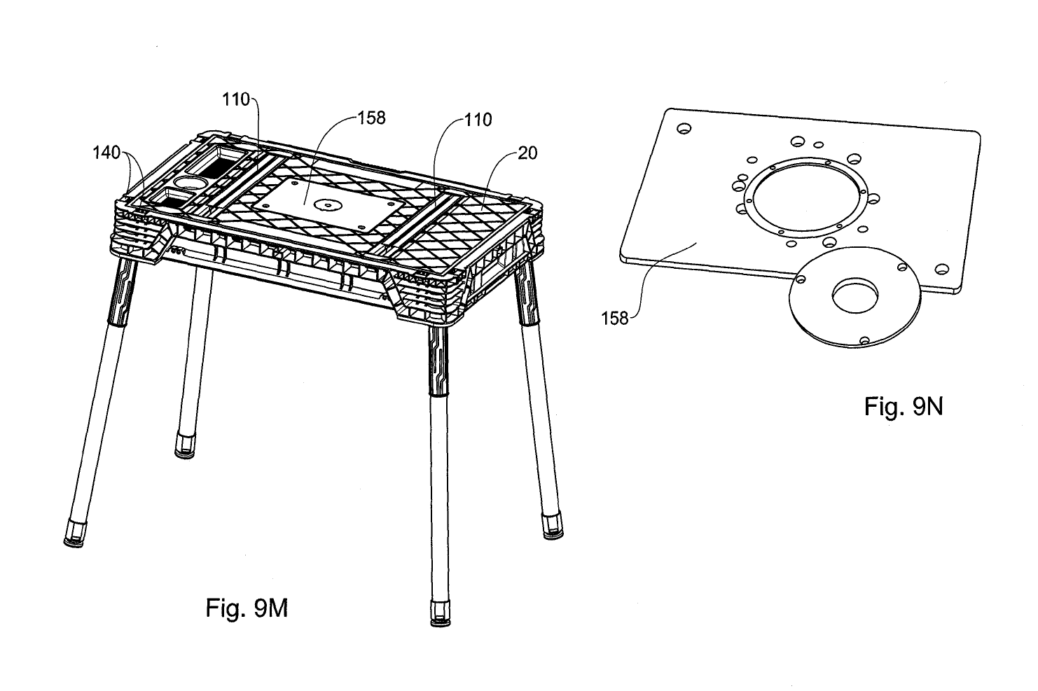

Further attention is now directed to FIGS. 9A to 9N directed to several examples of configurations of the utility member 12. In FIGS. 9A, 9H, 9G, 9I, 9L and 9M the utility member 12 is seen to comprise a pair of substantially parallely disposed T-slots 110 embedded within the top face 20. The T-slot 110, seen separately in FIG. 9C, is typically made of metal and is configured for slidingly receiving T-bolts (e.g. bolt 120 of FIG. 9F) which can be useful for supporting a workpiece (not shown) or a guide bar 124 (FIGS. 9H, 9G and 9J). The T-slot 110 can also be used for sliding articulation thereto of sliding clamps 126 (FIG. 9C) useful for example for securing a workpiece and the like.

The utility member 12 is further configured (typically at front/rear/side walls) with several hooks 130 (FIG. 9G) which can be used for articulation of personal articles while working (e.g. gloves, safety goggles, etc., or for articulation thereto of a shoulder carrying strap (not shown).

The utility member 12 is configured with eight hook connecting slots 140 disposed at respective corners of the top face 20 of the utility member, for detachably attaching thereto hooks 144 (seen for example in FIGS. 9B, 9E), wherein the hooks 144 are configured with a mounting portion 146 configured for arresting within the slots 140, and a support hook portion 148 for mounting gear thereon, such as a cable (not shown) or for supporting a beam 150, whereby the effective work area is significantly extended.

As best seen in FIG. 9B, the hooks are generally S shaped having a mounting portion configured for attachment to a respective slot on a workbench and a support portion 148 which is configured to secure a beam or any other accessory so as to provide a functional extension to the workbench as seen for example in FIG. 9D and FIG. 9K. Such an arrangement comprising several hooks can provide for a larger surface area when a plate is mounted thereover for example or can provide for a sawhorse like arrangement which will allow working over the beams 150 as desired. It will be appreciated that such S like shaped hooks can be utilized for various uses, e.g. to connect together two workbench surface, where the mounting portion is connected to one table and the hook support portion supports snuggly thereover the sidewall of the other table thus further extending surface areas (not seen).

In FIG. 9I there is illustrated the mounting and securing of a work plate 150 by screws 152, whereby the work plate 150 is configured with indicia such as length, angles and parallel lines. This work plate can be made of wood, plastic or metal and however can be readily replaced by a router plate 158 (FIGS. 9M, 9N).

1.-23. (canceled)

24. A workbench comprising a utility member having a top face, a bottom face and side walls and a plurality of support legs, wherein the workbench is manipulable between an operative position in which the support legs are detachably attached at leg mounts configured at the bottom face of the workbench, and a stowed position in which the support legs are detached from the leg mounts and are stowed within leg receptacles and wherein at the stowed position the support legs are fully received within receiving receptacles configured at the utility member and do not project from the utility member.

25. The workbench according to claim 24, wherein at the stowed position the overall size of the workbench is that of the utility member itself, with all elements and components thereof being fully received therein, thus not projecting from any surface of the utility member.

26. The workbench according to claim 24, wherein at the stowed position the support legs are received within a leg receptacle configured at the bottom face of the workbench.

27. The workbench according to claim 24, wherein at the stowed position the support legs are received within leg receptacles configured at one or more side walls of the workbench.

28. The workbench according claim 24, wherein the support legs are configured at their top end with a mounting arrangement for fast attaching/detaching from the leg mounts.

29. The workbench according to claim 24, wherein (i) the support legs are configured for snap attachment within the leg receptacle, at the stowed position, (ii) the support legs are configured for sturdy and fast mounting and detaching to/from leg mounts configured at the bottom face of the workbench, or (iii) the support legs are configured for snap articulation into leg mounts configured at the bottom face of the workbench.

30. The workbench according to claim 24, wherein the support legs are configured for screw-coupling to the leg mounts configured at the bottom face of the workbench.

31. The workbench according to claim 24, wherein the support legs are configured with a bayonet type articulation into leg mounts configured at the bottom face of the workbench.

32. The workbench according to claim 24, wherein the support legs are configured at bottom ends thereof with a ground engaging pad, wherein the ground engaging pad is configured with anti-slip surfacing, and/or wherein the ground engaging pad is configured for tilting about a longitudinal axis of the support leg, to thereby self-adjust to uneven surfaces.

33. The workbench according to claim 24, wherein the support legs are configured for height adjusting, for leveling the utility member.

34. The workbench according to claim 24, wherein the workbench is configured with one or more organizers detachably attachable thereto.

35. The workbench according to claim 34, the organizer is detachably attachable at a bottom face of the utility member.

36. The workbench according to claim 34, wherein the organizer is configured for sealingly attachment to the utility member.

37. The workbench according to claim 24, wherein the utility member is configured with receptacles/compartments/trays configured at the top face thereof.

38. The workbench according to claim 24, wherein tool utility member is configured for detachably attaching thereto utility hooks.

39. The workbench according to claim 38, wherein the utility hooks are configured for mounting thereon various equipment/gear and for supporting beams.

40. The workbench according to claim 39, wherein the utility hooks are configured for supporting rectangular cross-sectioned beams.

41. The workbench according to claim 39, wherein the utility hook is configured with a mounting portion configured for arresting within respective slot, and a support hook portion configured to receive and for mounting gear thereon.

42. The workbench according to claim 39, wherein the utility member is configured with modular work utilities, either fixed or replaceable.
